(19) United States
(12) Patent Application Publication
(10) Pub. No.: US 2024/0403484 A1
(43) Pub. Date: Dec. 5, 2024

(54) PRIVACY-PROTECTING MIXED REALITY RECORDING

(71) Applicant: Apple Inc., Cupertino, CA (US)

(72) Inventors: Torsten BECKER, Victoria Harbour (CA); Maneli NOORKAMI, Menlo Park, CA (US); Emily K. VAN HAREN, Sunnyvale, CA (US); Afshin Taghavi NASRABADI, Los Gatos, CA (US); David P. WENGER, San Jose, CA (US)

(21) Appl. No.: 18/513,500

(22) Filed: Nov. 17, 2023

Related U.S. Application Data
(60) Provisional application No. 63/470,951, filed on Jun. 4, 2023.

(51) Int. Cl. G06F 21/62; G06T 19/00

(52) U.S. Cl. CPC G06F 21/6254; G06T 19/006

(57) ABSTRACT

The subject technology provides a framework for privacy-protecting mixed reality and/or virtual reality recordings and/or for providing mixed and/or virtual reality video streams for display on external devices. A first process on an electronic device can receive, from a second process on the electronic device, a frame of a video stream. In some aspects, the frame includes an indicator of privacy-sensitive content The first process can obfuscate at least a portion of the frame based at least in part on the indicator of the privacy-sensitive content. The first process can provide the obfuscated at least the portion of the frame for at least one of: inclusion in a recorded video or for on stream display another electronic device.

### CROSS-REFERENCE TO RELATED APPLICATION(S)

This application claims the benefit of U.S. Provisional Application Ser. No. 63/470,951, entitled “PRIVACY-PROTECTING MIXED REALITY RECORDING,” and filed on Jun. 4, 2023, the disclosure of which is expressly incorporated by reference herein in its entirety.

### TECHNICAL FIELD

The present description relates generally to computer-generated reality recording, including privacy-protecting mixed reality recording.

### BACKGROUND

Augmented reality technology aims to bridge a gap between computer-generated environments and a physical environment by providing an enhanced physical environment that is augmented with electronic information. As a result, the electronic information appears to be part of the physical environment as perceived by a user. In an example, augmented reality technology further provides a user interface to interact with the electronic information that is overlaid in the enhanced physical environment.

### BRIEF DESCRIPTION OF THE DRAWINGS

The novel features of the subject technology are set forth in the appended claims. However, for purposes of explanation, several embodiments of the subject technology are set forth in the following figures.

FIG. 1 illustrates an example system architecture including various electronic devices that may implement the subject system in accordance with one or more implementations of the subject technology.

FIG. 2 illustrates an example electronic device providing privacy-protecting mixed reality recording in accordance with one or more implementations of the subject technology.

FIG. 3 conceptually illustrates a process for privacy-protecting mixed reality recording in accordance with one or more implementations of the subject technology.

FIG. 4 illustrates an example of privacy-protecting mixed reality recording in accordance with implementations of the subject technology.

FIG. 5 illustrates another example of privacy-protecting mixed reality recording in accordance with implementations of the subject technology.

FIG. 6 conceptually illustrates an example of an electronic system with which some embodiments of the subject technology are implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The subject technology relates to the obfuscation of personal information during the recording of mixed reality (MR) content within a headset or live streaming to other devices, such as a video stream to a display device and/or through copresence. The disclosed system and method aim to protect sensitive user information by obfuscating specific elements within the recorded or streamed frames on a per-frame basis. The obfuscation process includes identifying and flagging frames that include user interface (UI) windows, such as those displaying password entry fields, with a privacy flag. This flag can be set by a third-party application, first-party application, or system process. In addition to UI windows, the system may also provide for obfuscating other elements, such as hand positions, virtual keyboards, or any other user input representation that may reveal private and/or sensitive information, such as passwords, pins, and the like. To achieve this, the system employs a selective obfuscation approach by querying an underlying process to determine image regions in each frame that have the potential to disclose sensitive user information. Although the sensitive and/or private regions are obfuscated in the recorded and/or streamed frames, they remain visible to the user wearing the headset (referred to as HMD user) since the in-headset display is exclusively viewable by the user.

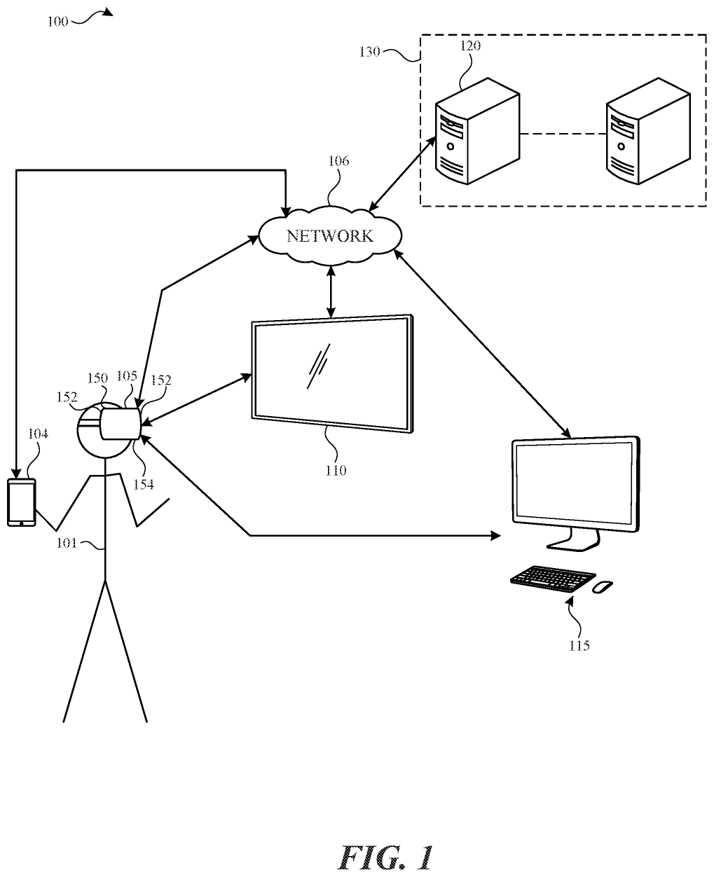

These and other embodiments are discussed below with reference to FIGS. 1-6. However, those skilled in the art will readily appreciate that the detailed description given herein with respect to these Figures is for explanatory purposes only and should not be construed as limiting.

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 is illustrated in FIG. 1 s a head-mounted portable system (e.g., worn by a user 101); however, the electronic device 105 may also be implemented, for example, as a tablet device, a handheld and/or mobile device. The electronic device 105 includes a display system capable of presenting a visualization of a computer-generated reality environment to the user. The electronic device 105 may be powered with a battery and/or another power supply. In an example, the display system of the electronic device 105 provides a stereoscopic presentation of the computer-generated reality environment, enabling a three-dimensional visual display of a rendering of a particular scene, to the user. In one or more implementations, instead of, or in addition to, utilizing the electronic device 105 to access a computer-generated reality environment, the user may use a handheld electronic device 104, such as a mobile device, tablet, watch, and the like.

The electronic device 105 may include one or more cameras such as camera(s) 150 (e.g., visible light cameras, infrared cameras, etc.). Further, the electronic device 105 may include various sensors 152 including, but not limited to, cameras, image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User input detected by such sensors and/or hardware elements correspond to, for example, various input modalities for performing one or more actions, such as initiating video capture of physical and/or virtual content. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc.

In one or more implementations, the electronic device 105 may be communicatively coupled to a base device the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 while physically connected).

When the electronic device 105 operates in the wireless tethered mode or the connected mode, a least a portion of processing user inputs and/or rendering the computer-generated reality environment may be offloaded to the base device thereby reducing processing burdens on the electronic device 105. For instance, in an implementation, the electronic device 105 works in conjunction with the electronic device 115 to generate a computer-generated reality environment including physical and/or virtual objects that enables different forms of interaction (e.g., visual, auditory, and/or physical or tactile interaction) between the user and the generated computer-generated reality environment in a real-time manner. In an example, the electronic device 105 provides a rendering of a scene corresponding to the computer-generated reality environment that can be perceived by the user and interacted with in a real-time manner. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload.

The network 106 may communicatively (directly or indirectly) couple, for example, the electronic device 104, the electronic device 105, the electronic device 110, and/or the electronic device 115 with each other device and/or the server 120. In one or more implementations, the network 106 may be an interconnected network of devices that may include, or may be communicatively coupled to, the Internet.

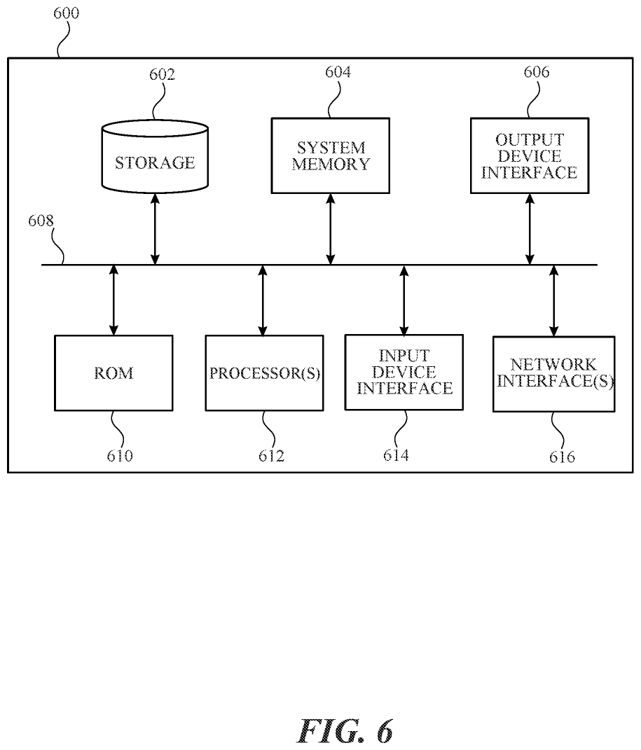

In FIG. 1, by way of example, the electronic device 110 is depicted as a television. The electronic device 110 may include a touchscreen and may be, for example, a television that includes a touchscreen, a smartphone that includes a touchscreen, a portable computing device such as a laptop computer that includes a touchscreen, a companion device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any electronic device with a touchpad. In one or more implementations, the electronic device 110 may not include a touchscreen but may support touchscreen-like gestures, such as in a computer-generated reality environment. In one or more implementations, the electronic device 110 may include a touchpad. In one or more implementations, the electronic device 110, the handheld electronic device 104, and/or the electronic device 105 may be, and/or may include all or part of, the electronic device discussed below with respect to the electronic system discussed below with respect to FIG. 6. In one or more implementations, the electronic device 110 may be another device such as an Internet Protocol (IP) camera, a tablet, or a companion device such as an electronic stylus, etc.

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 8.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for computer-generated reality environments. In an implementation, the server 120 may function as a cloud storage server that stores any of the aforementioned computer-generated reality content generated by the above-discussed devices and/or the server 120.

The subject technology provides for applying various effects aimed at obfuscating privacy-sensitive content, such as a password entry. These effects may include blurring or other suitable methods. For instance, the password entry flag could be associated with a frame that includes a password entry field, thereby enabling the option to blur the entire frame or selectively obfuscate specific regions based on relevant context attributes. Examples of such context attributes may involve the detection of hands, keyboards, including reflections in a scene, such as mirrors. As such, in one or more implementations, the subject system can obfuscate appropriate portions of the frame, thereby safeguarding privacy and confidentiality, while still preserving the visibility of the remainder of the frame.

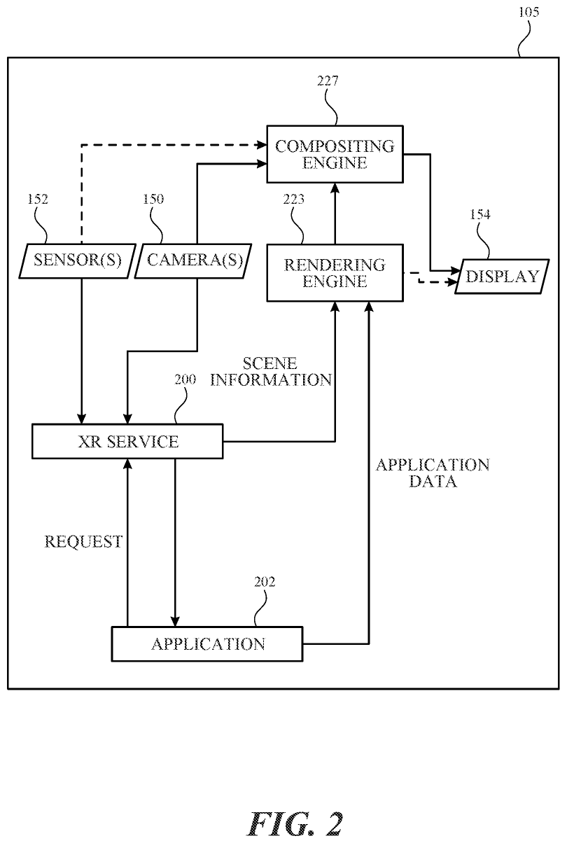

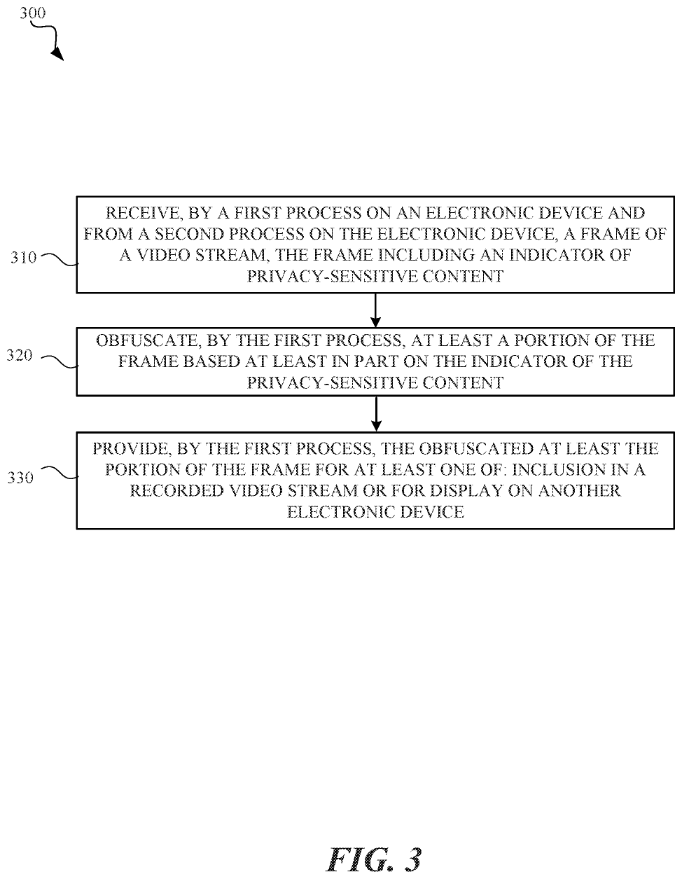

In one or more implementations discussed further below with respect to FIGS. 2 and 3, a user utilizing the electronic device 105, and/or utilizing the electronic device 104, may access a computer-generated reality environment that provides for display of user interface objects and/or elements for receiving privacy-sensitive content and triggers for obfuscation of such privacy-sensitive content from any streams and/or renderings of the computer-generated reality environment that are visible to other users. However, in order to determine whether obfuscation will be performed on a content frame, the electronic device 105 and/or the electronic device 104 may first detect whether a privacy flag is present within the content frame. Responsive to detecting presence of the privacy flag, obfuscation can be performed on the entire content frame or on a portion of the content frame containing the privacy-sensitive content.

A video file, or at least a portion thereof, such as a video frame, can be obfuscated to ensure the privacy of the recorded content, for example when input of a password is included in the recording. In one or more implementations, merely obfuscating and/or hiding the password being input and/or the password entry user interface, may be insufficient as additional information, such as hand movements during keyboard input may also need to be obfuscated and/or hidden. The subject system provides for automatically providing this obfuscation functionality to applications. For example, any password entry user interface element utilized by an application can trigger a protected mode when the user interacts with it. This behavior can be utilized in various scenarios, including a settings interface, where every time a passcode or password is entered, the system may enter the protected mode. Considering other use cases, such as co-presence sessions where multiple users may be collectively participating in a collaborative session, the application of the system's features can be further implemented with this protected mode.

FIG. 2 illustrates how a system process of the electronic device 105 may provide privacy-protecting of mixed reality recording. For example, FIG. 2 illustrates an example architecture that may be implemented by the electronic device 105 in accordance with one or more implementations of the subject technology. For explanatory purposes, portions of the architecture of FIG. 2 are described as being implemented by the electronic device 105 of FIG. 1, such as by a processor and/or memory of the electronic device; however, appropriate portions of the architecture may be implemented by any other electronic device, including the electronic device 110, electronic device 115, and/or server 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 2 can be implemented in software or hardware, including by one or more processors and a memory device containing instructions, which when executed by the processor cause the processor to perform the operations described herein. For example, in FIG. 2, the trapezoidal boxes may indicate that the sensors 152, the camera(s) 150 and the display 154 may be hardware components, and the rectangular boxes may indicate that the XR service 200, the application 202, the rendering engine 223, and the compositing engine 227 may be implemented in software, including by one or more processors and a memory device containing instructions, which when executed by the processor cause the processor to perform the operations described herein.

In the example of FIG. 2, an application such as application 202 provides application data to a rendering engine 223 for rendering of the application data, such as for rendering of a UI of the application 202. Application 202 may be a gaming application, a media player application, a content-editor application, a training application, a simulator application, a social media application, or generally any application that provides a UI or other content for display at a location that depends on the physical environment, such as by anchoring the UI or other content to an anchor in the physical environment. The application data may include application-generated content (e.g., windows, buttons, tools, characters, images, videos, etc.) and/or user-generated content (e.g., text, images, etc.), and information for rendering the content in the UI. In one or more implementations, rendering engine 223 renders the UI of the application 202 for display by a display such as display 154 of the electronic device 105. In one or more implementations, the XR service 200 may assign a portion of a physical environment of the electronic device to the application 202.

As shown in FIG. 2, additional information may be provided for display of the UI of the application 202, such as in a two-dimensional or three-dimensional (e.g., XR) scene. In the example of FIG. 2, sensors 152 may provide physical environment information (e.g., depth information from one or more depth sensors, motion information from one or more motion sensors), and/or user information to an XR service 200. Camera(s) 150 may also provide images of a physical environment and/or one or more portions of the user (e.g., the user's eyes, hands, face, etc.) to XR service 200. XR service 200 may generate scene information, such as three-dimensional map, of some or all of the physical environment of electronic device 105 using the environment information (e.g., the depth information and/or the images) from sensors 152 and camera(s) 150. The XR service 200 may also determine a gaze location based on images and/or other sensor data representing the position and/or orientation of the user's eye(s). The XR service 200 may also identify a gesture (e.g., a hand gesture) performed by a user of the electronic device 105, based on images and/or other sensor data representing the position and/or orientation of the user's hand(s) and/or arm(s).

As illustrated in FIG. 2, in one or more implementations, the application 202 may provide a request to the XR service 200. For example, the request may be a request for scene information (e.g., information describing the content of the physical environment), and/or a request for user information such as a request for a gaze location and/or user gesture information. In one example, the request may be an anchor request for a physical anchor (e.g., a horizontal surface, a vertical surface, a floor, a table, a wall, etc.).

Application 202 may include code that, when executed by one or more processors of electronic device 105, generates application data, for display of the UI of the application 202 on, near, attached to, or otherwise associated with an anchor location corresponding to the anchor identified by the identifier provided from XR service 200. Application 202 may include code that, when executed by one or more processors of electronic device 105, modifies and/or updates the application data based on user information (e.g., a gaze location and/or a gesture input) provided by the XR service 200.

Once the application data has been generated, the application data can be provided to the XR service 200 and/or the rendering engine 223, as illustrated in FIG. 2. As shown, scene information can also be provided to rendering engine 223. The scene information provided from the XR service 200 to the rendering engine 223 can include or be based on, as examples, environment information such as a depth map of the physical environment, and/or object information for detected objects in the physical environment. Rendering engine 223 can then render the application data from application 202 for display by display 154 of electronic device 105 to appear at a desired location in a physical environment. Display 154 may be, for example, an opaque display, and camera(s) 150 may be configured to provide a pass-through video feed to the opaque display. The UI of the application 202 may be rendered for display at a location on the display corresponding to the displayed location of a physical anchor object in the pass-through video. Display 154 may be, as another example, a transparent or translucent display. The UI of the application 202 may be rendered for display at a location on the display corresponding to a direct view, through the transparent or translucent display, of the physical environment.

As shown, in one or more implementations, electronic device 105 can also include a compositing engine 227 that composites video images of the physical environment, based on images from camera(s) 150, for display together with the UI of the application 202 from rendering engine 223. For example, compositing engine 227 may be provided in an electronic device 105 that includes an opaque display, to provide pass-through video to the display. In an electronic device 105 that is implemented with a transparent or translucent display that allows the user to directly view the physical environment, compositing engine 227 may be omitted or unused in some circumstances, or may be incorporated in rendering engine 223. Although the example of FIG. 2 illustrates a rendering engine 223 that is separate from XR service 200, it should be appreciated that XR service 200 and rendering engine 223 may form a common service and/or that rendering operations for rendering content for display can be performed by the XR service 200. Although the example of FIG. 2 illustrates a rendering engine 223 that is separate from application 202, it should be appreciated that, in some implementations, application 202 may render content for display by display 154 without using a separate rendering engine. Although a single instance of the application 202 is depicted in FIG. 2, it is appreciated that multiple applications may be running concurrently on the electronic device 105, receiving information corresponding to respective portions of the physical environment, and generating application data for rendering of respective UIs for display by display 154. In one or more implementations, compositing engine 227 may composite application data for multiple UIs of multiple applications for concurrent display.

In some implementations, the computing architecture as illustrated in FIG. 2 represents a streamlined pipeline, encompassing the flow of data from the application 202 to the rendering engine 223, passing through to the compositing engine 227, and finally reaching a recording process. In some implementations, the recording process is part of the compositing engine 227. In other implementations, the recording process is a separate process from the compositing engine 227. In some aspects, the recording process may include one or more similar functions as the compositing engine 227. For example, in one or more implementations, the recording process may receive metadata from the rendering engine 223 (and/or another process) that indicates the location and/or presence of individual user interface elements flagged as private or sensitive.

In the pipeline, the processing can originate from the application 202 which provides and/or indicates to the rendering engine 223 one or more user interface elements for rendering. Subsequently, the rendered one or more user interface elements are provided to the compositing engine 227 which composites the rendered user interface elements with a video stream, and the resulting frame is subsequently output by the compositing engine 227. From this stage, the frame is directed either to the display on the electronic device 105 and/or to the recording process. In some implementations, the obfuscation operation is performed by the recording process. In some aspects, metadata included in the frame information (e.g. by the compositing engine 227) may indicate that the content is private and/or sensitive.

Within this pipeline, a mechanism is implemented to detect specific frames and subsequently apply obfuscation such as a blurring effect to the entirety of a frame or multiple frames. For example, the flag indicating the need for obfuscating privacy-sensitive content can be set by a forefront application that owns the user interface (UI) field being inputted. The forefront application with which the user is interacting can set this flag to indicate the field is sensitive and should be obfuscated and/or to include a particular type of obfuscation, such as blurring. For example, the flag for blurring can be indicated by the applications 202.

The processing flow involves the flag being transmitted from, and/or indicated by, the application 202 to the rendering engine 223 and then to the compositing engine 227 where the flag may be included in, e.g., per frame metadata or per frame information. Subsequently, the flag is passed on to the recording process, enabling the implementation of the blurring effect by way of obfuscating one or more frames, or at least a portion of a frame. For example, the flag may be received by the recording process, which then proceeds to blur the entire frame that is recorded and/or shared beyond the device. In other implementations, the compositing engine 227 may apply the obfuscation to the frame. In some implementations, the privacy flag may be a single bit. In other implementations, the privacy flag may indicate whether multiple layers of the frame require obfuscation, such as in implementations where the distinction between the multiple layers is preserved beyond the compositing engine 227. For example, each layer may represent a separate component or element that contributes to the overall visual representation in the computer-generated reality environment. These layers can include the background scenery, three-dimensional (3D) objects, user interfaces, effects, and other graphical elements. Each layer can have its own properties, such as position, transparency, and depth, and they are combined together to create the final frame that is displayed to the user in the electronic device 105.

In the case of a keyboard password entry, the activation of the blurring functionality may be determined by either the application 202 or by a keyboard process (which may be an operating system process). A safeguard can be set in place to ensure that the system only stops applying the blurring effect when both the application 202 and the keyboard process agree that there is no longer a privacy concern, such as by no longer setting the privacy flag and/or indicator. Therefore, as long as either of the processes perceives privacy-sensitive activities, the entire system remains in the protected mode. In some implementations, the system can accommodate multiple processes that may be involved in privacy-sensitive operations. The interaction between the keyboard process and the application 202 is facilitated through a connection established between them, such as an inter-process communication. This connection may exist because the password text field, for example, may reside in one process while the virtual keyboard operates in a separate process. The connection allows the input from the virtual keyboard to be transferred to the application 202 when typing occurs, ensuring their synchronization and functionality.

In some implementations, where the field is not designated as privacy-sensitive or as a password entry field, the display of the content within the field may be controlled by the keyboard process itself. The responsibility for displaying the field content is attributed to the keyboard process rather than the application 202.

In some implementations, since the keyboard process operates locally on the electronic device 105, the password may be revealed by the keyboard process while the password is being input, instead of, for example, displaying dots or otherwise obfuscating the password. For example, the password may be shown as plaintext by the keyboard process, along with an accompanying notification indicating that the information is privacy protected and to assure the user that only they have visibility of this information.

In some implementations, the rendering engine 223 may determine the way specific regions within each frame should be obfuscated and can provide this information to the compositing engine 227, e.g., for subsequent passing to the recording process. Consequently, all operations conducted via the rendering engine 223 can be directed towards controlling the blurring of individual layers of the content.

In some implementations, compositing engine 227 may be responsible for taking rendered frames and combining them with other elements, such as a video stream. The compositing engine 227 may composite the rendered frames together, apply any necessary post-processing effects, and prepare the final image that is displayed by the computer-generated reality display device (e.g., the electronic device 105). The compositor can ensure that visual elements are properly layered and synchronized, providing a seamless and visually coherent experience to the user. In some implementations, the compositing engine 227 includes a descriptor layer that refers to a data structure or set of parameters that describe how a particular layer or image should be composited or rendered in a final output. The compositing engine 227 may further provide a video stream (e.g., stereoscopic or monoscopic) corresponding to the displayed content to the recording process.

In some implementations, recording process may store the received video stream as a video file and/or may stream the video stream to one or more devices and/or displays for viewing in real-time. Thus, the recording process can include a screen recording subprocess and a mirror casting subprocess for performing the recording and streaming, respectively.

In some implementations, when the presence of a privacy-sensitive field is detected, there exists both the version of the content visible to the user wearing the electronic device 105 as a head-mountable device, which is a rendered representation by the rendering engine 223 that may be composited with a video stream by the compositing engine 227, and a separate version where the entire frame is blurred by the recording process. This blurred version is transmitted to external displays via the recording process, ensuring that any sensitive content remains concealed.

In some implementations, the final frame that is sent by the compositing engine 227 to the recording process, can be tagged as privacy-sensitive. This tagged frame is then utilized by the recording process to blur or obfuscate the privacy-sensitive content of the frame and/or the frame entirely. In some implementations, the recording process, when being executed, is seamlessly integrated with the compositing engine 227, which allows it to receive the identical frame that would otherwise be displayed on the electronic device 105. This integration ensures that the recording process can accurately capture the content as intended without any deviation or alteration.

In the scenario where a password is being typed and there are two fields on the window, one associated with the keyboard process and the other with the application 202, there are specific elements within each window that determine the layer that requires blurring. In some implementations, the rendering engine 223 may determine to selectively indicate only the region of the window that reveals the content and the user's actions for blurring. This selective blurring approach allows for potential expansion and refinement of the blurring process to focus on specific areas of the application that require privacy protection.

If a streaming and/or casting session is active, such as streaming to a television in a conference room, the entire display can be blurred to prevent any visibility of the screen content, including passwords and user actions. However, in situations where multiple users are present in the same room wearing AR devices, it may be possible for one user to observe another user's hand movements and deduce the corresponding keyboard inputs. In this scenario, the system can automatically blur (or not display) the hands of one user for another user's observation, to prevent for the detection and extrapolation of finger movements in the air to approximate keyboard interactions. In some implementations, the knowledge of locating a user's gestures (e.g., hand motions) for implementing an obfuscation operation on pixels displaying such gestures may be acquired by using hands tracking (which may provide the rendering engine 223 with a 3D model of hand joints that the rendering engine 223 can utilize to render to the current camera perspective) or by using hands matting (which uses a trained machine learning model on the passthrough feed, trained on a data set of camera images with various types of hands in different physical environments, to identify regions of each 2D image that correspond to the user's hands).

The described system enables privacy obfuscation by allowing applications and/or operating system processes to provide information (e.g., a flag) indicating that specific user interface elements are privacy-sensitive. The information is propagated, e.g. in its entirety or in a derived form such as a per-frame flag, throughout the computing architecture pipeline, including the rendering engine 223, the compositing engine 227, and to the recording process as described with reference to FIG. 2. As a result, the entire screen can be blurred when privacy sensitivity is activated. The obfuscation may operate on a per-frame basis, ensuring that frames tagged as privacy-sensitive are effectively obfuscated. The blurring is applied, providing a real-time guarantee of privacy protection. Notably, the blurring is visible only to external users and does not impact a user's normal interactions with the electronic device 105, except when entering a password. In such cases, a virtual keyboard displays the entered text along with a visual indicator that only the user of the electronic device 105 can see the password in plaintext. This functionality remains intact even when sharing the screen over a wireless network or during a recording session.

In some implementations, selective obfuscation and/or blurring may be implemented to specifically obfuscate the hands or certain portions of the window screen. In the presence of a physical keyboard, the user's hands may be observable within the view. Consequently, in addition to the password field, it becomes possible to infer the content being typed based on hand movements. However, by utilizing a computer vision algorithm, the subject system can identify the location of the hands and the keyboard. Instead of blurring the entire frame, it becomes conceivable to selectively apply blurring to specific regions of the frame. Apart from blurring the entire frame, the option to selectively blur specific sections based on the aforementioned context attributes can be considered by one or more of the rendering engine 223, compositing engine 227 or the recording process as described with reference to FIG. 2.

In some implementations, a machine learning model may be used to predict gestures of a user. For example, the machine learning model can be trained (e.g., pre-trained) on different device(s) (e.g., one or more smartwatches other than the electronic device 105) based on sensor output data prior to being deployed on the electronic device 105. The sensor output data for training may correspond to output from one or more sensor(s) (e.g., similar to the sensor(s) 152). In one or more implementations, the machine learning model may have been trained across multiple users, for example, who provided different types of gestures while wearing a device (e.g., another smartwatch and confirmed the gestures (e.g., via a training user interface) as part of a training process. In this manner, the machine learning model may be used, in one or more implementations, to predict gestures across a general population of users, rather than one specific user. In some implementations, the machine learning model may be implemented as a convolutional neural network.

In some implementations, hand tracking information may be provided to the recording process, enabling this process to determine the precise locations of hand movements on a frame-by-frame basis. Subsequently, selective blurring is applied exclusively to those specific determined areas. This approach ensures that only the relevant regions containing hand drawings undergo the blurring process, while preserving visibility in other parts of the frame.

In some implementations, the recording process can query an alternative process (not shown) to obtain metadata information regarding virtual objects in the frame, such as depth, position, privacy-sensitive, and the like. The recording process may independently conduct such queries to gather relevant details about objects present within the frame, enabling it to augment the understanding of the visual content and thereby effectuate, for example, a per object blurring/obfuscation instead of blurring/obfuscating the entire frame.

In some implementations, when a first frame is received that includes a flag or bit indicating that blurring should be applied, the frame (or a preceding frame) may be blurred and then frozen, or held, in the output or recorded video stream until a last frame is received that includes the flag or bit indicating that blurring should be applied. Thus, only the first frame, now obfuscated, is included in the video stream, effectively restricting the visibility to that static frame. Users can interact and explore within the frame, but any subsequent actions or movements may not be observable since only the static blurred frame remains visible. The processing continues until the recording process receives frame indicating that blurring/obfuscation no longer needs to be applied, at which time the recording process resumes outputting the un-obfuscated frames. In one or more implementations, the frames that have undergone obfuscation may be discarded to maintain privacy protection.

The aforementioned approach of blurring and holding static the first frame can ensure that actions such as sudden changes in viewing direction do not impact the recorded content. To achieve this, a transition may be applied, smoothly progressing from a non-blurred state to complete blur. Once the frame reaches the state of complete blur, it remains in that state for the duration during which the obfuscated flag is active. In this regard, continuous recording/playback may not be implemented, conserving power consumption. Additionally, by blurring the first frame, it prevents any visibility of evolving hand movements or other dynamic elements.

FIG. 3 conceptually illustrates a process for privacy-protecting mixed reality recording in accordance with one or more implementations of the subject technology. The process 300 is performed by the electronic device 105 shown in FIG. 1, the handheld electronic device 104 shown in FIG. 1, the electronic device 110 shown in FIG. 1, the electronic device 115 show in FIG. 1, or the server 120 shown in FIG. 1. For explanatory purposes, the process 300 is primarily described herein with reference to the electronic device 105 of FIG. 1. However, the process 300 is not limited to the electronic device 105 of FIG. 1, and one or more steps (or operations) of the process 300 may be performed by one or more other components of other suitable devices, including the electronic device 105, the electronic device 110, and/or the server 120. Further for explanatory purposes, the steps of the process 300 are described herein as occurring in serial, or linearly. However, multiple steps of the process 300 may occur in parallel. In addition, the steps of the process 300 need not be performed in the order shown and/or one or more steps of the process 300 need not be performed and/or can be replaced by other operations.

At step 310, the process 300 begins by receiving, such as by the recording process 240, a frame indicated as having privacy-sensitive content. In some aspects, receiving the frame further includes receiving multiple frames with at least one of the multiple frames having the privacy-sensitive content. Accordingly, the process 300 also includes determining to obfuscate each of the frames based at least in part on a protected mode being active. In some aspects, the protected mode becomes active based on user interaction with one or more user interface elements configured to receive at least in part the privacy-sensitive content. For example, the one or more user interface elements may represent a virtual keyboard displayed in a field of view of a device and the user interaction may represent hand gestures providing a password into a password entry field associated with the virtual keyboard. In some implementations, the receiving of the frame may include receiving multiple frames with each of the frames including the privacy-sensitive content. In this regard, the process 300 includes determining to obfuscate one of the frames. In some aspects, the one of the frames may correspond to a last frame in sequence within the plurality of frames.

In some implementations, the frame may have been indicated as having the privacy-sensitive content by a flag initially provided by and/or set by a corresponding application process. For example, the application process may directly set the privacy flag for any password entry fields or other private data entry fields (e.g., pin entry). In some aspects, the privacy-sensitive content includes one or more objects indicative of the one or more user interactions. For example, a user's interaction with a virtual keyboard for entry of a password into a password entry field may represent privacy-sensitive content.

At step 320, the process 300 includes detecting, such as by the recording process 240, an indicator, such as a flag, indicating the presence of the privacy-sensitive content. For example, the flag may be indicated on a per frame basis such as in metadata associated with the frame, in a header of the frame, or generally in any manner of conveying an indicator with a video frame.

At step 330, the process 300 includes obfuscating, e.g., via the recording process 240, at least a portion of the frame corresponding to the privacy-sensitive content. In some implementations, the at least a portion of the frame may include one or more objects that correspond to the privacy-sensitive content. In some aspects, the one or more objects include one or more of a virtual object or a physical object. In some aspects, a virtual object may include a virtual keyboard. In other aspects, a virtual object may include a password entry window. In some aspects, a physical object may include a representation of a user's hands, which may be identified in a camera image frame using one or more of a hands detection algorithm or a hands matting algorithm. In some implementations, the at least a portion of the frame may correspond to a region in the frame that includes the one or more objects. In some aspects, the obfuscating may include modifying pixels inside the region and refraining from modifying pixels outside of the region. In one or more implementations, obfuscating at least a portion of the frame may include obfuscating the entirety of the frame.

In some implementations, the process 300 may include sending a query requesting information pertaining to one or more objects in the at least a portion of the frame that correspond to the privacy-sensitive content (e.g., location, size, etc.), and receiving, responsive to the query, information indicating a location of the one or more objects within the at least a portion of the frame that corresponds to the privacy-sensitive content which may then be used to obfuscate the one or more objects. In some aspects, the obfuscating includes modifying the at least a portion of the frame corresponding to the location of the one or more objects based at least in part on the detection information.

At step 340, the process 300 includes providing, e.g., by the recording process 240, the obfuscated at least a portion of the frame for output, such as for recording, for streaming, and the like. For example, the obfuscated frame may be stored as recorded content in a recorded content repository. In another example, the obfuscated frame may be casted (e.g., transmitted) to a receiving device.

In some aspects, the process 300 includes generating a first composited frame that includes the frame with the privacy-sensitive content without obfuscation and a second composited frame that includes the obfuscated at least a portion of the frame. The process 300 also includes providing the first composited frame for display to a user of the electronic device 105. In some aspects, the providing the obfuscated at least a portion of the frame includes providing the second composited frame as recorded content for playback of the recorded content at a second device different from the electronic device 105. In some aspects, the electronic device 105 includes a computer-generated reality display device configured to display content to a user, and the second device may include a casting device configured to display at least a portion of the content provided for display on the first device.

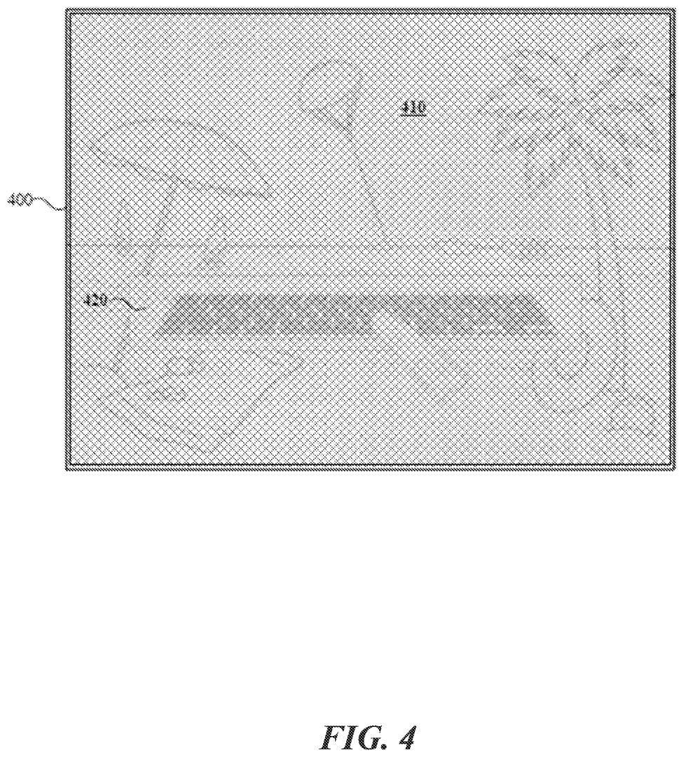

FIG. 4 illustrates an example of privacy-protecting mixed reality recording in accordance with implementations of the subject technology. In some implementations, a user utilizing the electronic device 105, and/or utilizing the electronic device 104, may access a computer-generated reality environment that provides for display UI objects for receiving privacy-sensitive content and triggers obfuscation of such privacy-sensitive content from the computer-generated environment and/or computer-generated reality environment being provided by the electronic device 105. However, in order to determine whether obfuscation will be performed on a content frame, the electronic device 105 and/or the electronic device 104 may first detect whether a privacy flag is present within the content frame. Responsive to detecting presence of the privacy flag, obfuscation can be performed on all or part of the content frame containing the privacy-sensitive content. As illustrated in FIG. 4, frame 400 includes a region 420 that includes location of a virtual keyboard and an object corresponding to a user gesture for entering a password entry via the virtual keyboard. The subject system can obfuscate the frame 400 in its entirety (e.g., 410) upon detection of the privacy flag in the frame 400. In some implementations, the frame 400 may include overlay information featuring an icon denoting password entries at a location corresponding to the virtual keyboard location.

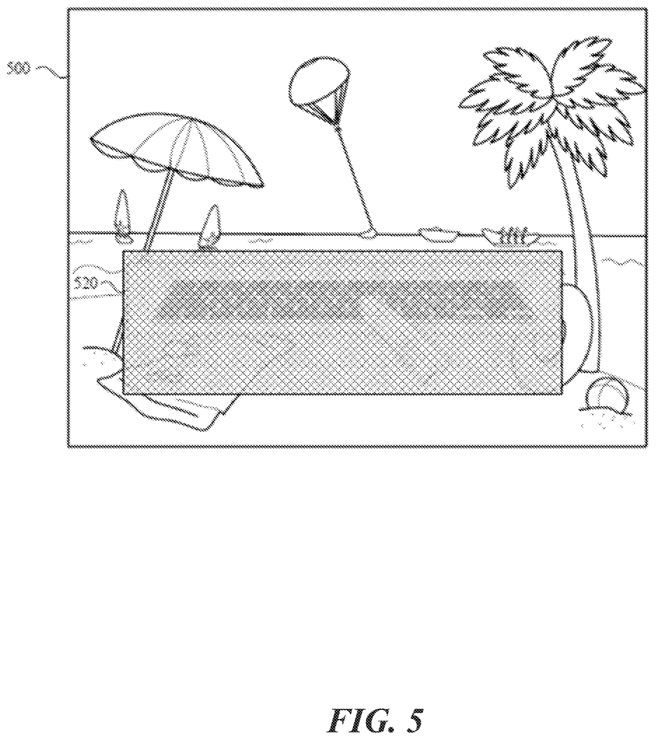

FIG. 5 illustrates another example of privacy-protecting mixed reality recording in accordance with implementations of the subject technology. In some implementations, selective blurring may be implemented to specifically obscure the hands or certain portions of the window screen. In the presence of a physical keyboard (not shown), the hands are observable within the view. Consequently, in addition to the password field, it may be possible to infer the content being typed based on hand movements. However, by utilizing a computer vision algorithm and/or by utilizing hand tracking, the subject system can identify the location of the hands and the keyboard. Instead of blurring the entire frame, it becomes conceivable to selectively apply blurring to specific regions of the frame. For instance, if the location of the virtual keyboard is known and suitable handling mechanisms are in place, it is plausible to solely blur a portion of the frame, thereby preserving visibility in other areas. As illustrated in FIG. 5, frame 500 includes a region 520 that includes location of a virtual keyboard and an object corresponding to a user gesture for entering a password entry via the virtual keyboard. The subject system can selectively blur the region 520 to obfuscate the virtual keyboard and the user gesture. In other implementations, instead of incorporating language-specific text, the obfuscated region 520 may include a blur alongside an icon indicating, e.g., “password dot dot dot.” Accordingly, this form of obfuscation, which is independent of language requirements, can mitigate the need to account for diverse textual representations in various languages. The obfuscated region 520, in other implementations, may include informative text to apprise users of their restricted visibility.

In the present disclosure, it may be recognized that user input, such as entering a password on a virtual keyboard, requires particular attention. The subject system may detect and locate the virtual keyboard, enabling precise targeting of obfuscation. However, it may be crucial to consider a broader area of coverage beyond the virtual keyboard itself. For instance, if a user presses on the left side of a key, it should still fall within the obfuscated region. Accordingly, the subject system can extend the obfuscated region beyond the boundaries of the virtual keyboard, encompassing a larger area. This approach introduces uncertainty by way of the applied obfuscation, preventing observers from discerning specific hand movements or inferring the precise location solely based on the blurred hand near the virtual keyboard's edge. The intention is to minimize the information available about the approximate region of interaction, ensuring a higher level of privacy.

As described above, one aspect of the present technology is the gathering and use of data available from specific and legitimate sources for allowing privacy-protecting mixed reality recording. The present disclosure contemplates that in some instances, this gathered data may include personal information data that uniquely identifies or can be used to identify a specific person. Such personal information data can include audio data, demographic data, location-based data, online identifiers, telephone numbers, email addresses, home addresses, biometric data or records relating to a user's health or level of fitness (e.g., vital signs measurements, medication information, exercise information, motion information, heartrate information workout information), date of birth, or any other personal information.

The present disclosure recognizes that the use of such personal information data, in the present technology, can be used to the benefit of users. For example, the personal information data can be used for allowing a trusted device to modify a security state of a target device.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data. For example, in the example of generating physiological predictions, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

FIG. 6 illustrates an electronic system 600 with which one or more implementations of the subject technology may be implemented. The electronic system 600 can be, and/or can be a part of, the electronic device 105 shown in FIG. 1, the handheld electronic device 104 shown in FIG. 1, the electronic device 110 shown in FIG. 1, the electronic device 115 show in FIG. 1, and/or the server 120 shown in FIG. 1. The electronic system 600 may include various types of computer readable media and interfaces for various other types of computer readable media. The electronic system 600 includes a bus 608, one or more processing unit(s) 612, a system memory 604 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a flash drive and its corresponding solid-state drive) may be used as the permanent storage device 602. Like the permanent storage device 602, the system memory 604 may be a read-and-write memory device. However, unlike the permanent storage device 602, the system memory 604 may be a volatile read-and-write memory, such as random-access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

The bus 608 also connects to the input device interface 614 and output device interface 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to one or more networks and/or to one or more network nodes, such as the electronic device 105 shown in FIG. 1, the handheld electronic device 104 shown in FIG. 1, the electronic device 110 shown in FIG. 1, the electronic device 115 show in FIG. 1, and/or the server 120 shown in FIG. 1, through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Many of the above-described features and applications are implemented as software processes that are specified as a set of instructions recorded on a computer readable storage medium (also referred to as a computer readable medium). When these instructions are executed by one or more computational or processing unit(s) (e.g., one or more processors, cores of processors, or other processing units), they cause the processing unit(s) to perform the actions indicated in the instructions. In this specification, the term “software” is meant to include firmware residing in read-only memory or applications stored in magnetic storage which can be read into memory for processing by a processor. Also, in some embodiments, multiple software programs can be implemented as sub-parts of a larger program while remaining distinct software programs. In some embodiments, multiple software programs can also be implemented as separate programs. Finally, any combination of separate programs that together implement a software program described here is within the scope of the subject technology. In some embodiments, the software programs, when installed to operate on one or more electronic systems, define one or more specific machine implementations that execute and perform the operations of the software programs.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “trusted device”, “target device”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, by a first process on an electronic device and from a second process on the electronic device, a frame of a video stream, the frame comprising an indicator of privacy-sensitive content;
obfuscating, by the first process, at least a portion of the frame based at least in part on the indicator of the privacy-sensitive content; and
providing, by the first process, the obfuscated at least the portion of the frame for at least one of: inclusion in a recorded video stream or for display on another electronic device.

2. The method of claim 1, further comprising:
providing, by the second process, the frame for display on the electronic device substantially concurrently with the receiving of the frame by the first process.

3. The method of claim 2, wherein the electronic device comprises a computer-generated reality display device configured to display the frame to a user, and wherein the other electronic device comprises a display device configured to display the obfuscated at least the portion of the frame to another user.

4. The method of claim 1, wherein the receiving the frame of the video stream comprises receiving a plurality of frames of the video stream including the frame, and the method further comprises:
determining to obfuscate each of the plurality of frames based at least in part on a protected mode being active, wherein the protected mode becomes active based on user interaction with one or more user interface elements configured to receive at least in part the privacy-sensitive content.

5. The method of claim 1, wherein the receiving the frame of the video stream comprises receiving a plurality of frames of the video stream including the frame with each of the plurality of frames comprising the indicator of the privacy-sensitive content, and the method further comprises:
determining to obfuscate one of the plurality of frames, wherein the one of the plurality of frames corresponds to a first frame of the plurality of frames that comprises the indicator, wherein the first frame is obfuscated and held static in the recorded video stream until a last frame of the plurality of frames that comprises the indicator is received.

6. The method of claim 1, wherein the at least the portion of the frame includes one or more objects that correspond to the privacy-sensitive content, wherein the one or more objects include one or more of a virtual object or a physical object.

7. The method of claim 6, wherein the virtual object includes one or more of a virtual keyboard or a password entry window, and wherein the physical object includes a representation of a user's hands identified in a camera image frame using one or more of a hands detection algorithm or a hands matting algorithm.

8. The method of claim 6, wherein the at least the portion of the frame corresponds to a region in the frame that includes the one or more objects, wherein the obfuscating comprises modifying pixels inside the region and refraining from modifying pixels outside of the region.

9. The method of claim 1, further comprising:
sending a query requesting detection of one or more objects in the at least the portion of the frame that corresponds to the privacy-sensitive content; and
receiving, responsive to the query, detection information indicating a location of the one or more objects within the at least the portion of the frame that corresponds to the privacy-sensitive content,
wherein the obfuscating comprises modifying the at least the portion of the frame corresponding to the location of the one or more objects based at least in part on the detection information.

10. The method of claim 1, wherein the frame comprises a plurality of layers, further comprising determining at least one layer of the plurality of layers that includes the privacy-sensitive content, wherein the obfuscating comprises obfuscating the at least one layer of the plurality of layers.

11. The method of claim 1, further comprising:
setting, via an application process separate from the first process and the second process, a flag corresponding to the privacy-sensitive content, wherein the indicator is added to the frame by the second process based at least in part by the flag.

12. The method of claim 11, further comprising:
detecting, via the application process, one or more user interactions with a user interface element indicative of an input corresponding at least in part to the privacy-sensitive content.

13. A system comprising:
a processor; and
a memory device containing instructions, which when executed by the processor cause the processor to perform operations comprising:
receiving, by a first process on an electronic device and from a second process on the electronic device, a frame of a video stream, the frame comprising an indicator of privacy-sensitive content;
obfuscating, by the first process, at least a portion of the frame based at least in part on the indicator of the privacy-sensitive content; and
providing, by the first process, the obfuscated at least the portion of the frame for inclusion in a recorded video stream.

14. The system of claim 13, wherein the operations further comprise:
providing, by the second process, the frame for display on the electronic device substantially concurrently with the receiving of the frame by the first process.

15. The system of claim 13, wherein the receiving the frame of the video stream comprises receiving a plurality of frames of the video stream including the frame, and wherein the operations further comprise:
determining to obfuscate each of the plurality of frames based at least in part on a protected mode being active, wherein the protected mode becomes active based on user interaction with one or more user interface elements configured to receive at least in part the privacy-sensitive content.

16. The system of claim 15, wherein the receiving the frame of the video stream comprises receiving a plurality of frames of the video stream including the frame with each of the plurality of frames comprising the indicator of the privacy-sensitive content, and wherein the operations further comprise:
determining to obfuscate one of the plurality of frames, wherein the one of the plurality of frames corresponds to a first frame of the plurality of frames that comprises the indicator.

17. The system of claim 13, wherein the operations further comprise:
sending a query requesting detection of one or more objects in the at least the portion of the frame that corresponds to the privacy-sensitive content; and
receiving, responsive to the query, detection information indicating a location of the one or more objects within the at least the portion of the frame that corresponds to the privacy-sensitive content,
wherein the obfuscating comprises modifying the at least the portion of the frame corresponding to the location of the one or more objects based at least in part on the detection information.

18. The system of claim 17, wherein the frame comprises a plurality of layers, further comprising determining at least one layer of the plurality of layers that includes the privacy-sensitive content, wherein the obfuscating comprises obfuscating the at least one layer of the plurality of layers.

19. The system of claim 13, wherein the operations further comprise:
setting, via an application process separate from the first process and the second process, a flag corresponding to the privacy-sensitive content, wherein the indicator is added to the frame by the second process based at least in part by the flag; and
detecting, via the application process, one or more user interactions with a user interface element indicative of an input corresponding at least in part to the privacy-sensitive content.

20. A non-transitory computer-readable medium comprising instructions, which when executed by a computing device, cause the computing device to perform operations comprising:
receiving, by a first process on an electronic device and from a second process on the electronic device, a frame of a video stream, the frame comprising an indicator of privacy-sensitive content;
obfuscating, by the first process, at least a portion of the frame based at least in part on the indicator of the privacy-sensitive content; and
providing, by the first process, the obfuscated at least the portion of the frame for display on another electronic device.
